(19) United States
(12) Patent Application Publication
(10) Pub. No.: US 2017/0127705 A1
(43) Pub. Date: May 11, 2017

(54) ATMOSPHERE CONTROL IN TRANSPORT UNIT

(71) Applicant: THERMO KING CORPORATION, Minneapolis, MN (US)

(72) Inventors: Radim CERMAK, Prague (CZ); Jiri ZITA, Brno (CZ); Lubos FOREJT, Statenice (CZ)

(21) Appl. No.: 15/317,713

(22) PCT Filed: Jun. 11, 2015
(86) PCT No.: PCT/US2015/035367

§ 371 Date: Dec. 9, 2016

Related U.S. Application Data
(60) Provisional application No. 62/010,726, filed on Jun. 11, 2014.

(51) Int. Cl. A23L 3/3409; A23B 7/148; A23L 3/3418

(52) U.S. Cl. CPC A23L 3/34095; A23L 3/3418; A23B 7/148; A23V 2002/00

(57) ABSTRACT

Methods, systems and apparatuses to help control atmosphere in a storage space, such as for example a storage space of a transport unit are disclosed. Generally, the embodiments herein are directed to provide a desired amount of nitrogen to the storage space to replace oxygen and carbon dioxide while removing the same amount of air from the storage space, which can help maintain a pressure balance between the storage space and the ambient atmosphere. Air directed out of the storage space and ambient air can be directed through an air separation device to separate a nitrogen portion. The nitrogen portion can be directed back to the storage space.

### FIELD

The disclosure herein relates to methods, systems and apparatuses directed to atmosphere control in a storage space of, for example, a transport unit (e.g. a truck trailer).

### BACKGROUND

In a storage space of, for example, a transport unit, atmosphere in the storage space can be controlled to help prolong shelf life of perishable goods, such as for example fruits and vegetables. In some cases, for example, nitrogen separated from the ambient air can be supplied to the storage space, so that, for example, an oxygen concentration and/or carbon dioxide concentration in the storage space can be controlled. Controlling the atmosphere in the storage space can, for example, reduce ripening effect of the perishable goods, which can help prolong the shelf life of the perishable goods.

### SUMMARY

Methods, systems and apparatuses configured to help control atmosphere in a storage space, such as for example a storage space of a transport unit are disclosed. Generally, an oxygen concentration and/or carbon dioxide concentration can be controlled in the storage space. A pressure in the storage space can also be controlled to be balanced (e.g. about the same) with an ambient pressure. The embodiments disclosed herein can help decrease an oxygen concentration and a carbon dioxide concentration simultaneously in the storage space. The embodiments disclosed herein can also help control and restrict air leakage from the storage space to the ambient air.

In some embodiments, a portion of air from the storage space (i.e. the storage air) can be directed out of the storage space. A nitrogen portion, which may substantially contain nitrogen, and a waste air portion, which may contain the remaining part of the air without the nitrogen portion, can be separated from the storage air. The nitrogen portion can be directed back to the storage space.

In some embodiments, ambient air can be provided to separate nitrogen from the ambient air. The separated nitrogen from the ambient air can be directed to the storage space to compensate for the waste air portion separated from the storage air, so that a pressure in the storage space can be maintained.

In some embodiments, an atmosphere control system for a storage space may include a storage air intake device configured to move air out of the storage space, and an ambient air intake device configured to provide ambient air. In some embodiments, the atmosphere control system can include an air separation device configured to separate a nitrogen portion and a waste air portion from the air moved out of the storage space and/or the ambient air provided by the ambient air intake device. In some embodiments, the atmosphere control system can include a gas supply device configured to supply the nitrogen portion to the storage space.

In some embodiments, the atmosphere control system can include a controller, which can be configured to control the ambient air intake device. In some embodiments, the ambient air intake device can be controlled so that an amount of the air directed into the storage space is about the same as an amount of the air moved out of the storage space by the storage air intake device.

In some embodiments, the atmosphere control can include a pressure sensing device configured to measure a pressure in the storage space and an ambient pressure. The controller can be configured to control the ambient air intake device so that the pressure in the storage space may be about the same as the ambient pressure.

In some embodiments, the atmosphere control system may include a first airflow metering device configured to measure the amount of the air moved out of the storage space by the storage air intake device, and a second airflow metering device configured to measure the amount of the ambient air provided by the ambient air intake device. The controller may be configured to obtain the amount of the air moved out of the storage space from the first airflow metering device, and obtain the amount of the ambient air provided by the ambient air intake device from the second airflow metering device.

In some embodiments, an amount of the air moved out of the storage space by the storage air intake device may be a relatively fixed value. In some embodiments, an amount of the ambient air provided by the ambient air intake device may be a relatively fixed value.

In some embodiments, the ambient air intake device may be controlled so that an amount of ambient air provided by the ambient air intake device may be about the same as an amount of the waste air portion.

In some embodiments, a method of controlling atmosphere in a storage space may include: directing a storage air portion out of the storage space; providing an ambient air portion; separating a nitrogen portion and a waste air portion from the storage air portion and the ambient air portion; and directing the nitrogen portion to the storage space. The waste air portion can be disposed to the ambient.

In some embodiments, an amount of the nitrogen portion directed to the storage space may be about the same as an amount of the storage air portion. In some embodiments, an amount of the ambient air portion may be the same as an amount of the waste air portion.

Other features and aspects of the systems, methods, and control concepts will become apparent by consideration of the following detailed description and accompanying drawings.

### BRIEF DESCRIPTION OF THE DRAWINGS

Reference is now made to the drawings in which like reference numbers represent corresponding parts throughout.

FIG. 1 illustrates a transport unit, with which the embodiments disclosed herein can be practiced.

FIG. 2 illustrates a schematic diagram of an atmosphere control system.

FIG. 3 illustrates an atmosphere control system, according to one embodiment.

FIG. 4 illustrates an atmosphere control system, according to another embodiment.

FIG. 5 illustrates an atmosphere control system, according to another embodiment.

FIG. 6 illustrates an atmosphere control system, according to another embodiment.

FIG. 7 illustrates an atmosphere control system, according to another embodiment.

FIG. 8 illustrates an atmosphere control system, according to yet another embodiment.

### DETAILED DESCRIPTION

Perishable goods, such as fruits and vegetables, can consume oxygen and produce carbon dioxide (e.g. due to a ripening effect of the perishable goods) when being stored or in transport. The ripening effect can reduce shelf life of the perishable goods. To help prolong the shelf life of the perishable goods, atmosphere in a storage space of, for example, a transport unit (e.g. a truck trailer) can be controlled. During transport, the ripening effect of the perishable goods can continuously cause the concentrations of the oxygen and/or carbon dioxide in the storage space to change, which may cause undesirable effects on the shelf life of the goods. It may be desired to control the atmosphere in the storage space during transport and/or storage of the perishable goods.

In some cases, nitrogen can be supplied to the storage space to replace, for example, oxygen and/or carbon dioxide, which can help reduce the concentrations of oxygen and carbon dioxide. The nitrogen can be supplied to the storage space to replace both oxygen and carbon dioxide when, for example, the concentrations of both the oxygen and the carbon dioxide are above their corresponding set points. In some cases, for example, when the carbon dioxide concentration exceeds the set point while the oxygen concentration is at or below the set point, supplemental ventilation (e.g. opening a ventilation port or compressor to direct ambient air to the storage space) can be used to provide the ambient air to the storage space so as to dilute the carbon dioxide. However, supplemental ventilation can cause the oxygen concentration to rise. The term “ambient” generally refers to atmosphere external to and/or outside of a storage space.

Embodiments disclosed herein are directed to methods, systems and apparatuses configured to help control atmosphere in a storage space such as, for example, a storage space of a transport unit. Generally, the embodiments herein are directed to provide a desired amount of nitrogen to the storage space to replace oxygen and/or carbon dioxide while removing the same amount of air from the storage space, which can help maintain a pressure balance between the storage space and an ambient atmosphere. In some embodiments, air from the storage space can be directed out of the storage space and recalculated through an air separation device (e.g. a nitrogen separation membrane) back to the storage space. In some embodiments, a desired amount of ambient air can be directed through the air separation device to compensate for a waste air portion (e.g. oxygen and/or carbon dioxide separated by the air separation device) from the air separation device. The embodiments disclosed herein can work with another system such as, for example, a transport refrigeration system, to provide desired atmosphere conditions in the storage space.

It is understood that nitrogen separated from air may include some amount of oxygen and/or carbon dioxide, as well as other types of non-nitrogen components. Similarly, oxygen and carbon dioxide separated from air may include some amount of nitrogen or other types of non-oxygen or carbon dioxide components. References are made to the accompanying drawings that form a part hereof, and in which is shown by way of illustration of the embodiments in which the embodiments may be practiced. It is to be understood that the term used herein are for the purpose of describing the figures and embodiments and should not be regarded as limiting the scope.

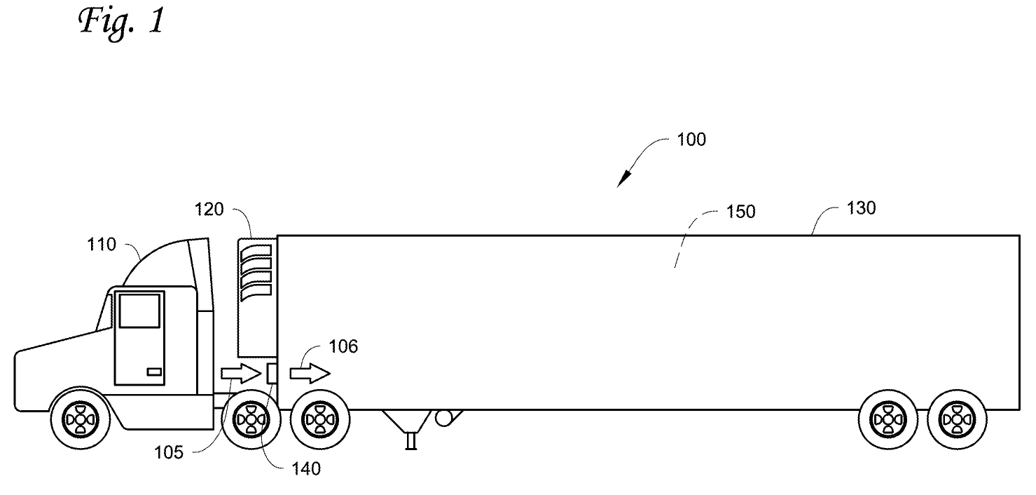

FIG. 1 illustrates a temperature controlled truck trailer 100 that includes a truck 110 and a trailer 130, with which the embodiments disclosed herein can work. The trailer 130 is equipped with a transport refrigeration unit (TRU) 120 and an atmosphere control system 140.

The TRU 120 may be configured to control a temperature in a storage space 150 of a trailer 130. The atmosphere control system 140 can be configured to control an atmosphere composition such as, for example, an oxygen concentration and/or a carbon dioxide concentration in the storage space 150. The atmosphere control system 140 can be configured to separate nitrogen from, for example, ambient air 105 and supply separated nitrogen 106 to the storage space 150. The TRU 120 and the atmosphere control system 140 can work together to provide a desired atmospheric condition for perishable goods such as, for example, vegetables and fruits in transport.

It is to be appreciated that the embodiments disclosed herein is not limited to a transport unit, such as for example, a trailer (e.g., trailer on flat car, etc.), a container (e.g., container on flat cars, intermodal container, etc.), a truck, a box car, etc. The embodiments disclosed herein can generally work with a storage space of such as, for example, a refrigeration unit, a cold room, etc.

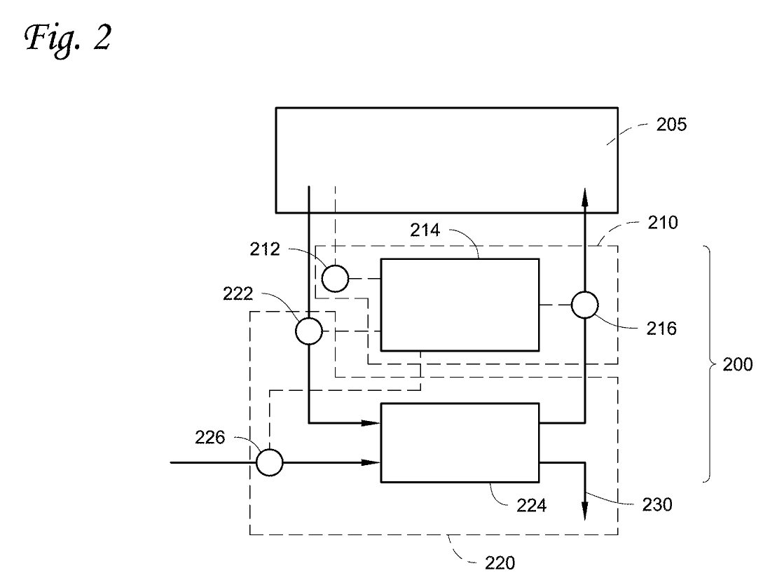

FIG. 2 illustrates a schematic diagram of an atmosphere control system 200 that is configured to help control atmosphere in a storage space 205.

The atmosphere control system 200 can be generally configured to help balance a pressure in the storage space 205 with the ambient. The atmosphere control system 200 can also be configured to, for example, help control an oxygen concentration, a nitrogen concentration and/or a carbon dioxide concentration in the storage space so that the oxygen concentration, nitrogen concentration and/or carbon dioxide concentration may be, for example, at about the respective set points. Balancing the pressure in the storage space 205 can help avoid infiltration of ambient air directly into the storage space 205. Controlling the oxygen and carbon dioxide concentrations can help, for example, reducing the ripening effect of perishable goods, which can help prolong shelf life of the perishable goods.

The atmosphere control system 200 can include a pressure balancing circuit 210 and a controlled atmosphere module 220. The pressure balancing circuit 210 can be configured to detect a pressure balance (or a pressure difference) between a pressure in the storage space 205 and an ambient pressure. The pressure balancing circuit 210 can be configured to maintain a desired pressure balance. In the illustrated embodiment, the pressure balancing circuit 210 includes a pressure sensing device 212, a pressure balance controller 214 and a gas supply device 216.

The controlled atmosphere module 220 that can be configured to regulate an atmosphere composition (e.g. an oxygen concentration and/or a carbon dioxide concentration) in the storage space 205. The controlled atmosphere module 220 can be configured, for example, to provide nitrogen and/or carbon dioxide to the storage space 205 to replace oxygen and modify carbon dioxide concentration. In the illustrated embodiment, the controlled atmosphere module 220 includes a storage air intake device 222, an air separation device 224, and an ambient air intake device 226.

The pressure sensing device 212 is generally configured to sense a pressure difference between the pressure in the storage space 205 and the ambient pressure. In some embodiments, the pressure sensing device 212 can include a first pressure sensor to measure a first pressure in the storage space 205, and a second pressure sensor to measure the ambient pressure. The pressure difference between the storage space 205 and the ambient pressure can be derived by subtracting the first pressure and the ambient pressure. In some embodiments, the pressure sensing device 212 can be a differential pressure sensor, which may be configured to obtain the pressure difference directly.

The pressure balance controller 214 can be configured to obtain and/or derive the pressure difference between the storage space 205 and the ambient pressure from the pressure sensing device 212. In some embodiments, the pressure balance controller 214 can be configured to control a gas supply device 216 so that the pressure of the storage space 205 and the ambient pressure can be balanced (e.g. the pressure difference between the storage space 205 and the ambient pressure is about 0). For example, when the pressure in the storage space 205 is below the ambient pressure, the gas supply device 216 can be configured to supply a relatively large amount of gas to the storage space 205. When the pressure in the storage space is higher than the ambient pressure, the gas supply device 215 can be configure to supply a relatively small amount of gas to the storage space 205.

The gas supply device 216 is generally configured to direct air into and/or out of the storage space 205. In some embodiments, the gas supply device 216 can include an actuation device (not shown) such as, for example, an air compressor and/or an air valve. In some embodiments, the pressure balance controller 214 can be configured to control the actuation device (e.g. the air compressor and/or an air valve) of the gas supply device 216 to regulate, for example, an amount of air directed into and/or out of the storage space 205.

It is to be appreciated that the pressure balancing circuit 210 can also be configured to maintain the pressure difference between the storage space 205 and the ambient pressure at a value that is not about zero, (e.g. a positive value or a negative value). In some embodiments, for example, maintaining a positive pressure difference between the storage space 205 and the ambient pressure (e.g. the pressure in the storage space 205 is higher than the ambient pressure) may help prevent/reduce leakage of ambient air into the storage space 205. In some embodiments, for example, maintaining a negative pressure difference (e.g. the pressure in the storage space 205 is lower than the ambient pressure) may help decrease CO₂ concentration in the storage space 205. In some embodiments, an automatic pressure relieve vale preset to a certain pressure could be also used to maintain a pressure balance between the storage space 205 and the ambient.

The controlled atmosphere module 220 can be configured, for example, to provide nitrogen to the storage space 205 to replace oxygen and carbon dioxide. It is to be appreciated that the controlled atmosphere module 220 can control the atmosphere composition in the storage space 205 by other methods and systems (e.g., via CO₂ injection, via a fresh air exchange mechanism, etc.). In some embodiments, the storage space 205 may be equipped with a ventilation system to direct air in or out of the storage space 205. In some embodiments, the CO₂ concentration in the storage space 205 may be regulated by CO₂ scrubbing using, for example, a device absorbing CO₂. In some embodiments, the CO₂ concentration in the storage space 205 may be regulated by a pressure swing adsorption system. In some embodiments, the CO₂ concentration in the storage space 205 may be regulated by CO₂ injection using, for example, a CO₂ cylinder or tank. In some embodiments, the storage space 205 may be injected with a desired atmosphere, and the storage space 205 may be sealed during transportation. It is noted that the approaches as disclosed herein can be used separately or in combination.

Generally, the storage air intake device 222 can be configured to draw air from the storage space 205 and direct the storage air from the storage space 205 toward the air separation device 224. The ambient air intake device 226 can be generally configured to draw air from the ambient and direct the ambient air toward the air separation device 224. The air separation device 224 can be generally configured to substantially separate nitrogen from the air (the storage air and/or the ambient air) provided to the air separation device 224. After the air is separated by the air separation device 224, generally oxygen and carbon dioxide can be substantially separated from nitrogen. The nitrogen separated by the air separation device 224, which in some cases can contain more than about 95% of nitrogen and less than about 5% of oxygen, can be directed into the storage space 205 to regulate oxygen and/or carbon dioxide concentrations in the storage space 205.

The controlled atmosphere module 220 can be configured to work with the pressure balancing circuit 210 so that, for example, an amount of air drawn out of the storage space 205 is about the same as an amount of air supplied by the gas supply device 216, which can help balance the pressure between the storage space 205 and the ambient pressure. It is appreciated that the amount of air drawn out of the storage space 205 can also be different from the amount of air supplied by the gas supply device 216 in some embodiments.

In some embodiments, the storage air intake device 222 and/or the ambient air intake device 226 can include an actuation device (not shown) such as, for example, an air compressor and/or an air valve. In some embodiments, the pressure balance controller 214 can be configured to control the actuation device (e.g. the air compressor and/or an air valve) of the storage air intake device 222 and/or the ambient air intake device 226 to regulate, for example, an amount of air moving through the devices.

In operation, when, for example, the oxygen concentration and/or the carbon dioxide concentration exceed their respective set points, the storage air intake device 222 can be activated to draw air out of the storage space 205. The air drawn from the storage space 205 can be directed through the air separation device 224 to substantially separate the nitrogen and the oxygen and carbon dioxide. The nitrogen portion can be directed back to the storage space 205, and the oxygen and carbon dioxide portion can be disposed to the ambient as one portion of waste air 230.

Because the oxygen and carbon dioxide portion of the air drawn from the storage space 205 may be disposed to the ambient (e.g. as the waste air 230), an amount of the air directed back to the storage space 205 can be less than the amount of air drawn from the storage space 205. This can cause a pressure differential between the storage space 205 and the ambient pressure. To compensate for the difference, the ambient air intake device 226 can be activated to provide the ambient air to the air separation device 224, and nitrogen separated from the provided ambient air can be directed toward the storage space 205. Oxygen and carbon dioxide separated from the provided ambient air can be disposed to the ambient as another portion of the waste air 230.

In some embodiments, an amount of the ambient air provided by the ambient air intake device 226 can be the same as an amount of the waste air 230. In some embodiments, the amount of waste air 230 produced in operation can be determined, for example, in a laboratory setting. The ambient air intake device 226 can be configured to allow a desired amount of ambient air intake, where the desired amount of ambient air intake can be about the same as the amount of the waste air 230 determined in the laboratory setting. The ambient air intake device 226 can be, for example, a preset valve that can be configured to move a relatively fixed amount of air there through. In some embodiments, the airflow may be within a range of about 10 to about 100 liters per minute (l/min). In some embodiments, the pressure of the airflow may be at a value between about 5 to about 10 bar (g).

In some embodiments, the storage air intake device 222, the ambient air intake device 226 and/or the supply gas device 216 can have one or more airflow metering devices (not shown) configured to measure an amount of airflow flowing through the devices. The air balance controller 214 can be configured to control the ambient air intake device 226 so that the amount of the air flowing through the supply gas device 216 can be about the same as the amount of air flowing through the storage air intake device 222.

It is to be appreciated that in some embodiments, the pressure sensing device 212 may not be necessary. For example, in some embodiments, when one or more airflow metering devices may be used in the atmosphere control system 200, the pressure sensing device 212 may not be necessary.

In some embodiments, the pressure balance controller 214 can be configured to regulate the storage intake device 222, the ambient air intake device 226 and/or the supply gas device 216, so that the pressure in the storage space 205 and the ambient pressure may be about the same or at about a desired difference value.

It is to be appreciated that the storage intake device 222 may be regulated using various approaches or a combination of approaches. In some embodiments, the storage intake device 222 may be a throttled air path with a desired design, such as for example, a tube with a desired dimension, an orifice with a desired opening size, a preset valve, etc. The storage intake device 222 may not need to be controlled by the pressure balance controller 214 in some embodiments (e.g. a tube with a desired dimension, an orifice with a fixed configuration, a preset valve). In some embodiments, the storage intake device 222 may be an on/off valve. In some embodiments, the storage intake device 222 may be a proportional valve. In some embodiments, the storage intake device 222 may be a set of one or more valves.

In some embodiments, the control of the pressure balance controller 214 may take into account CO₂ and/or O₂ concentrations, relatively humidity, and/or concentrations of other gases such as for example ethylene. A control mode of the pressure balance controller 214 may also take into account how far the concentrations of the gases (e.g. CO₂, O₂, ethylene) deviate from the desired concentrations. In some embodiments, for example, when CO₂ and O₂ concentrations are both above desired values, or when CO₂ concentration is above the desired value, while the O₂ is about the desired value, the pressure balance controller 214 may use a closed loop control scheme (e.g. as described in FIG. 2).

In some embodiments, when, for example, the CO₂ concentration is above a desired value while the O₂ concentration is below a desired value, a ventilation valve (not shown) of the storage space 205 may be opened to direct ambient air into the storage space 205.

Generally, with respect to pressure balancing control, when the pressure in the storage space 205 is relatively high compared to the ambient pressure, the supply air intake device 222 can be configured to draw a relatively large amount of air from the storage space 205 and/or the supply gas device 216, and can be configured to direct a relatively small amount of air into the storage space 205. The ambient air intake device 226 can be configured to be closed or draw a relatively small amount of air from the ambient. This can help reduce the pressure in the storage space 205. In some embodiments, the ambient air intake device 226 may not be needed, as the ambient air can be directed directly into the air separation device 224.

When the pressure in the storage space 205 is relatively low compared to the ambient pressure, the supply air intake device 222 can be configured to be closed or draw a relatively small amount of air from the storage space 205. The supply gas device 216 can be configured to direct a relatively large amount of air into the storage space 205. The ambient air intake device 226 can be configured to draw a relatively large amount of ambient air. The control can be accomplished by, for example, the pressure balance controller 214. This can help increase the pressure in the storage space 205.

Generally, with respect to an atmosphere composition control, the ripening effect of perishable goods (e.g. fruits and vegetables) can consume oxygen and produce carbon dioxide during storage. Due to the ripening effect, the composition in the air in the storage space 205 can change when perishable goods are stored. The controlled atmosphere module 220 can be configured to provide nitrogen to replace oxygen and/or carbon dioxide in the air so as to reduce the concentrations of the oxygen and/or carbon dioxide in the air when the concentrations of the oxygen and carbon dioxide, for example, exceed the respective set points. In some embodiments, the nitrogen can be supplied from a nitrogen tank. In some embodiments, the nitrogen can be separated by the air separation device 224. The embodiments as disclosed herein can be configured to recirculate at least a portion of the air in the storage space 205 through the air separation device 224, so that, for example, excessive oxygen and/or carbon dioxide can be removed from the air in the storage space as a portion of the waste air 230. The separated nitrogen can be circulated back to the storage space 205. To compensate for the oxygen and/or carbon dioxide removed from the air directed out of the storage space 205, the controlled atmosphere module 220 can be configured to supply the ambient air to the air separation device 224 for separating nitrogen. The nitrogen separated from the ambient air can be supplied to the storage space 205, which may help maintain the pressure balance between the storage space 205 and the ambient.

In some embodiments, a method of controlling atmosphere in a storage space (e.g. the storage space 205) may include: directing a portion of air from the storage space out of the storage space, substantially separating a first nitrogen portion from the portion of air from the storage space, and directing the first nitrogen portion into the storage space. In some embodiments, the method of controlling atmosphere in the storage space can include substantially separating a second nitrogen portion from ambient air and directing the second nitrogen portion to the storage space. In some embodiments, an amount of the portion of air directed out of the storage space may be about the same as a sum of the first nitrogen portion and the second nitrogen portion. In some embodiments, the method of controlling atmosphere in the storage space can include separating a second nitrogen portion from an amount of ambient air and directing the second nitrogen portion to the storage space so that a pressure in the storage space may be about the same as an ambient pressure.

It is to be appreciated that FIG. 2 illustrates a schematic diagram of the atmosphere control system 200. Components as illustrated in FIG. 2 can be removed in some embodiments. In some embodiments, components can be added to the atmosphere control system 200 illustrated in FIG. 2.

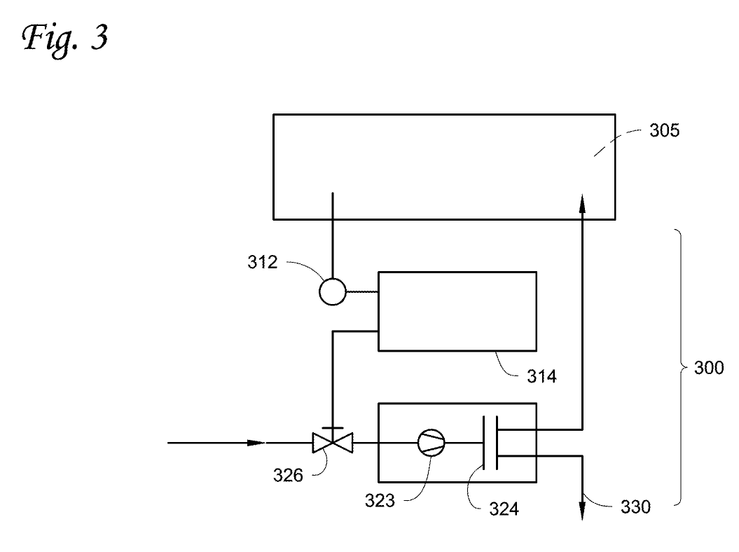

FIGS. 3 to 6 illustrate exemplary embodiments of atmosphere control systems 300 to 600 respectively.

Referring to FIG. 3, the atmosphere control system 300 includes a pressure sensing device 312, a controller 314, an ambient air intake device 326, an air compressor 323, and an air separation device 324.

In operation, the pressure sensing device 312 can detect a pressure difference between a pressure in a storage space 305 and an ambient pressure. The pressure difference can be obtained by the controller 314 to control the ambient air intake device 326. The controller 314 can be configured to, for example, increase or decrease an amount of ambient air intake by controlling the ambient air intake device 326, so that the pressure in the storage space 305 is about the same as the ambient pressure, or is about a desired pressure difference from the ambient pressure.

The ambient air can be directed into the compressor 323 and the air separation device 324 to substantially separate nitrogen from the ambient air. The separated nitrogen portion can be directed into the storage space 305 to help maintain a desired oxygen and/or carbon oxide concentration in the storage space 305. The remaining portion of the ambient air can be disposed to the ambient as waste air 330.

The ambient air intake device 326, as illustrated, can include a valve (not shown) that can be controlled by the controller 314. It is appreciated that the ambient air intake device 326 can include other types of devices (e.g. a compressor) that can be controlled to regulate an amount of airflow.

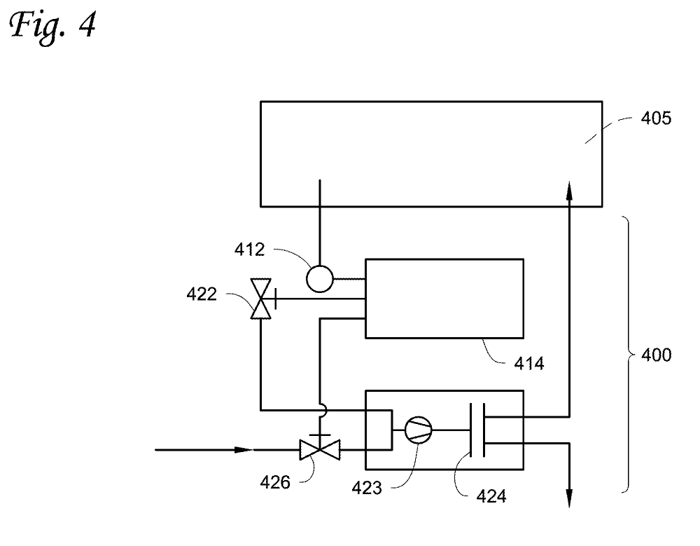

FIG. 4 illustrates an atmosphere control system 400. Compared with the atmosphere control system 300 illustrated in FIG. 3, the atmosphere control system 400 includes a pressure sensing device 412, a controller 414, an ambient air intake device 426, an air compressor 423, and an air separation device 424, with the addition of a storage air intake device 422.

The storage air intake device 422 is generally configured to move some air from a storage space 405 out of the storage space 405 and direct the air through the air compressor 423 and the air separation device 424 to separate the nitrogen. The storage air intake device 422 can be controlled by the controller 414. The storage air intake device 422, as illustrated, can include a valve (not shown) that can be controlled by the controller 414. It is appreciated that the storage air intake device 422 can include other types of devices (e.g. a compressor) that can be controlled to regulate an amount of airflow.

In operation, the pressure sensing device 412 can detect a pressure difference between a pressure in the storage space 405 and an ambient pressure. The pressure difference can be obtained by the controller 414 to control the ambient air intake device 426 and/or the storage air intake device 422. The controller 414 can be configured to, for example, increase or decrease an amount of airflow through the ambient air intake device 426 and/or the storage air intake device 422, so that the pressure in the storage space 405 is about the same as the ambient pressure, or is about a desired pressure difference from the ambient pressure.

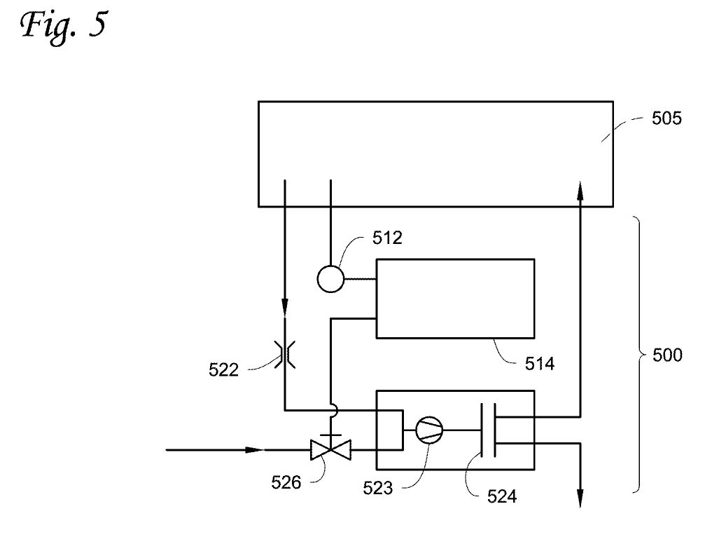

FIG. 5 illustrates the atmosphere control system 500 that is configured to control atmosphere in a storage space 505. Compared with the atmosphere control system 300 illustrated in FIG. 3, the atmosphere control system 500 includes a pressure sensing device 512, a controller 514, an ambient air intake device 526, an air compressor 523, and a air separation device 524, with the addition of a storage air intake device 522. The storage air intake device 522 may be configured to move a relatively fixed amount of air out of the storage space 505, and generally does not need to be controlled by the controller 514. The storage air intake device 522 can include, for example, a preset valve that can be configured to move a relatively fixed amount of air there through.

In operation, the storage air intake device 526 may be configured to move a desired amount of air out of the storage space 505 continuously. The pressure sensing device 512 can detect a pressure difference between a pressure in a storage space 505 and an ambient pressure. The pressure difference can be obtained by the controller 514 to control the ambient air intake device 526. The controller 514 can be configured to, for example, increase or decrease an amount of ambient air intake by controlling the ambient air intake device 526, so that the pressure in the storage space 505 is about the same as the ambient pressure, or is about a desired pressure difference from the ambient pressure.

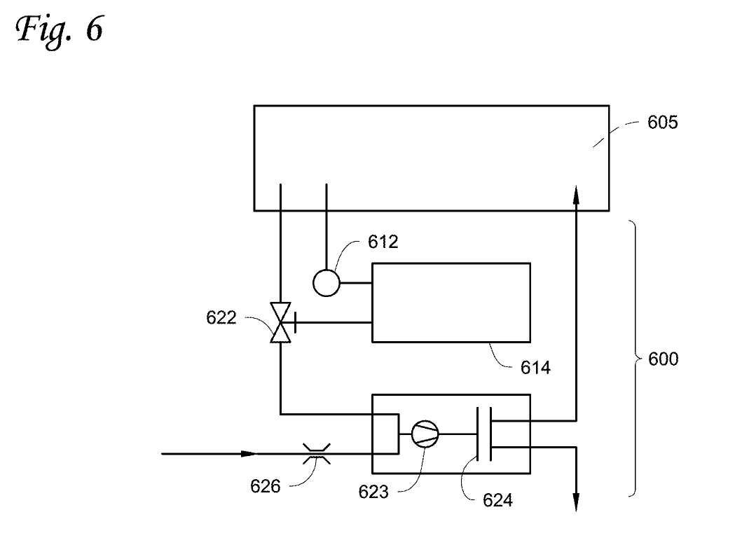

FIG. 6 illustrates the atmosphere control system 600 that is configured to control atmosphere in a storage space 605. The atmosphere control system 600 includes a pressure sensing device 612, a controller 614, a storage air intake device 622, an ambient air intake device 626, an air compressor 623, and an air separation device 624. Compared with the atmosphere control system 400 as illustrated in FIG. 4, the ambient air intake device 626 can be configured to move a relatively fixed amount of ambient air, and is generally configured to not to be controlled by the controller 614. The ambient air intake device 622 can include, for example, a preset valve can be configured to move a relatively fixed amount of air there through.

In operation, the ambient air intake device 626 may be configured to move a desired amount of ambient air. The pressure sensing device 612 can detect a pressure difference between a pressure in a storage space 605 and an ambient pressure. The pressure difference can be obtained by the controller 614 to control the storage air intake device 622. The controller 614 can be configured to, for example, increase or decrease an amount of the storage air moved out of the storage space 605 by controlling the storage air intake device 622, so that the pressure in the storage space 605 is about the same as the ambient pressure, or is about a desired pressure difference from the ambient pressure.

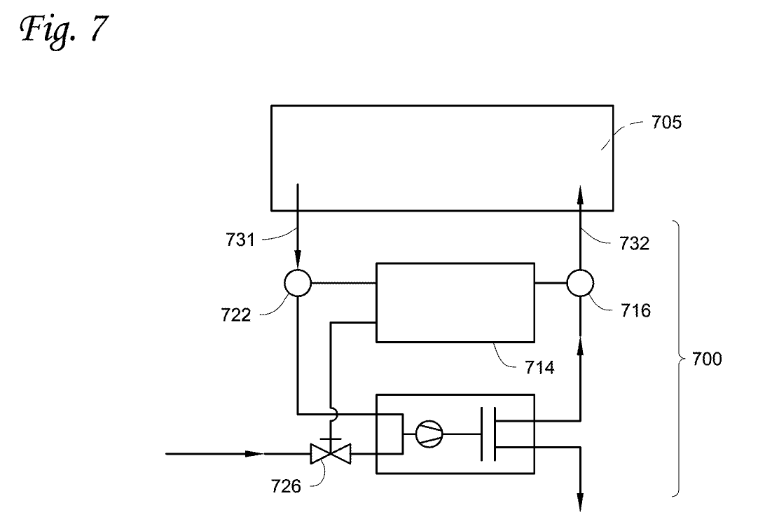

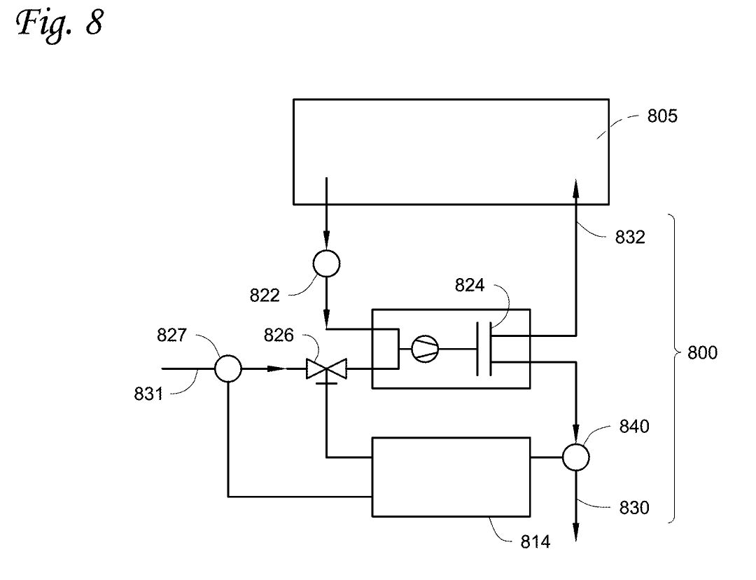

FIGS. 7 and 8 illustrate atmosphere control systems 700 and 800 that generally do not include a pressure sensing device, such as the pressure sensing device 312 as illustrated in FIG. 3.

The atmosphere control system 700 as illustrated in FIG. 7 is generally configured to measure an amount of airflow 731 removed from a storage space 705 and an amount of airflow 732 that is delivered into the storage space 705. The atmosphere control system 700 can include a storage air intake device 722, an ambient air intake device 726, a controller 714 and a gas supply device 716.

The storage air intake device 722 and the gas supply device 716 can include an airflow metering device configured to obtain an amount of the airflow 731 moved by the storage air intake device 722 and an amount of the airflow 732 moved by the gas supply device 716. The controller 714 can obtain the amount of the airflow 731 and 732, and control an amount of airflow through the ambient air intake device 726 so that the amount of the airflow 731 and the amount of airflow 732 are about the same, or are about a desired difference.

It is to be appreciated that the ambient air intake device 726, the storage air intake device 722 and the gas supply device 716 can include valves, pumps, and/or compressors (not shown) that can be regulated by the controller 714, so that an amount of airflow through the ambient air intake device 726, the storage air intake device 722 and/or the gas supply device 716 can be regulated.

Referring to FIG. 8, the atmosphere control system 800 is generally configured to measure an amount of waste air 830 from an air separation device 824 and an amount of ambient air 831 directed to the air separation device 824. The atmosphere control system 800 is generally configured to balance the amount of the waste air 830 and the amount of ambient air 831.

The atmosphere control system 800 can include a controller 814, an ambient air metering device 827 configured to measure the amount of ambient air, a waste air metering device 840 configured to measure the amount of waste air 830, the controller 814, and an ambient air intake device 826. The atmosphere control system 800 can also include a storage air intake device 822 configured to move a portion of air out of the storage space 805.

In operation, ambient air 831 and air from the storage space 805 can be directed toward the air separation device 824. The air separation device 824 can separate a nitrogen portion 832 from the waste air 830. The nitrogen portion 832 can be directed into the storage space 805. The waste air 830 can be disposed to the ambient. The ambient air intake device 826 may include, for example, a valve that can be controlled by the controller 814 to vary the amount of ambient air 831 directed toward the air separation device 824. The controller 814 can be configured to obtain the amount of the ambient air 831 and the amount of the waste air 830, and control the ambient air intake device 826 so that the amount of the ambient air 831 is about the same as the amount of the waste air. By balancing the amount of the ambient air 831 and the amount of the waste air 830, a pressure inside a storage space 805 can be maintained.

It is appreciated that components as illustrated in FIGS. 3 to 8 can be used in separation or combined. It is also appreciated that the air separation device is one example of air separation devices. Air separation devices configured to separate other components from the air can also be used with the embodiments as disclosed herein. The term “air separation device” generally refers to a device or apparatus configured to separate one or more components (e.g. nitrogen, oxygen, or carbon dioxide) from other components of the air (e.g. waste air).

### Aspects

It is appreciated that any of aspects 1-11 can be combined with any of aspects 12-16.

Aspect 1. An atmosphere control system for a storage space, comprising:

a storage air intake device configured to move air out of the storage space;

an ambient air intake device configured to provide ambient air;

an air separation device configured to separate a first air portion and a waste air portion from the air moved out of the storage space and the ambient air provided by the ambient air intake device; and

a gas supply device configured to supply the first air portion to the storage space.

Aspect 2. The atmosphere control system of aspect 1, further comprising:

a controller, wherein the controller is configured to control the ambient air intake device so that an amount of the air moved out of the storage space by the storage air intake device is the same as an amount of the ambient air provided by the ambient air intake device.

Aspect 3. The atmosphere control system of any of aspects 1-2, further comprising:

a pressure sensing device configured to measure a pressure in the storage space and an ambient pressure; and

a controller, wherein the controller is configured to control the ambient air intake device so that the pressure in the storage space is the same as the ambient pressure.

Aspect 4. The atmosphere control system of aspect 2, further comprising:

a first airflow metering device configured to measure the amount of the air moved out of the storage space by the storage air intake device; and

a second airflow metering device configured to measure the amount of the ambient air provided by the ambient air intake device;

wherein the controller is configured to obtain the amount of the air moved out of the storage space from the first airflow metering device, and obtain the amount of the ambient air provided by the ambient air intake device from the second airflow metering device.

Aspect 5. The atmosphere control system of any of aspects 1-4, wherein an amount of the air moved out of the storage space by the storage air intake device is a fixed amount.
Aspect 6. The atmosphere control system of any of aspects 1-5, wherein the storage air intake device is a preset valve.
Aspect 7. The atmosphere control system of any of aspects 1-6, wherein an amount of the ambient air provided by the ambient air intake device is a fixed amount.
Aspect 8. The atmosphere control system of any of aspects 1-7, wherein the ambient air intake device is a preset valve.
Aspect 9. The atmosphere control system of any of aspects 1-8, wherein the ambient air intake device is controlled so that an amount of ambient air provided by the ambient air intake device is the same as an amount of the waste air portion.
Aspect 10. The atmosphere control system of any of aspects 1-9, wherein the air separation device is an air separation device and the first air portion is nitrogen.
Aspect 11. The atmosphere control system of any of aspects 1-10, further comprising:

a pressure sensing device configured to measure a pressure in the storage space and an ambient pressure; and

a controller, wherein the controller is configured to control the ambient air intake device so that the pressure in the storage space and the ambient pressure has a desired pressure difference.

Aspect 12. A method of controlling atmosphere in a storage space, comprising:

directing a storage air portion out of the storage space;

providing an ambient air portion;

separating a first air portion and a waste air portion from the storage air portion and the ambient air portion; and

directing the first air portion to the storage space.

Aspect 13. The method of aspect 12, wherein an amount of the first air portion directed to the storage space is the same as an amount of the storage air portion.
Aspect 14. The method of any of aspects 12-13, wherein an amount of the ambient air portion is the same as an amount of the waste air portion.
Aspect 15. The method of any of aspects 12-14, wherein the first air portion is nitrogen.
Aspect 16. The method of any of aspects 12-15, wherein an amount of the first air portion directed to the storage space and an amount of the storage air portion are configured to maintain a desired pressure difference between a pressure in the storage space and an ambient pressure.

With regard to the foregoing description, it is to be understood that changes may be made in detail, without departing from the scope of the present invention. It is intended that the specification and depicted embodiments are to be considered exemplary only, with a true scope and spirit of the invention being indicated by the broad meaning of the claims.

1. An atmosphere control system for a storage space, comprising:
a storage air intake device configured to move air out of the storage space;
an ambient air intake device configured to provide ambient air;
an air separation device configured to separate a first air portion and a waste air portion from the air moved out of the storage space and the ambient air provided by the ambient air intake device; and
a gas supply device configured to supply the first air portion to the storage space.

2. The atmosphere control system of claim 1, further comprising:
a controller, wherein the controller is configured to control the ambient air intake device so that an amount of the air moved out of the storage space by the storage air intake device is the same as an amount of the ambient air provided by the ambient air intake device.

3. The atmosphere control system of claim 1, further comprising:
a pressure sensing device configured to measure a pressure in the storage space and an ambient pressure; and
a controller, wherein the controller is configured to control the ambient air intake device so that the pressure in the storage space is the same as the ambient pressure.

4. The atmosphere control system of claim 2, further comprising:
a first airflow metering device configured to measure the amount of the air moved out of the storage space by the storage air intake device; and
a second airflow metering device configured to measure the amount of the ambient air provided by the ambient air intake device;
wherein the controller is configured to obtain the amount of the air moved out of the storage space from the first airflow metering device, and obtain the amount of the ambient air provided by the ambient air intake device from the second airflow metering device.

5. The atmosphere control system of claim 1, wherein an amount of the air moved out of the storage space by the storage air intake device is a fixed amount.

6. The atmosphere control system of claim 1, wherein the storage air intake device is a preset valve.

7. The atmosphere control system of claim 1, wherein an amount of the ambient air provided by the ambient air intake device is a fixed amount.

8. The atmosphere control system of claim 1, wherein the ambient air intake device is a preset valve.

9. The atmosphere control system of claim 1, wherein the ambient air intake device is controlled so that an amount of ambient air provided by the ambient air intake device is the same as an amount of the waste air portion.

10. The atmosphere control system of claim 1, wherein the air separation device is an air separation device and the first air portion is nitrogen.

11. The atmosphere control system of claim 1, further comprising:
a pressure sensing device configured to measure a pressure in the storage space and an ambient pressure; and
a controller, wherein the controller is configured to control the ambient air intake device so that the pressure in the storage space and the ambient pressure has a desired pressure difference.

12. A method of controlling atmosphere in a storage space, comprising:
directing a storage air portion out of the storage space;
providing an ambient air portion;
separating a first air portion and a waste air portion from the storage air portion and the ambient air portion; and
directing the first air portion to the storage space.

13. The method of claim 12, wherein an amount of the first air portion directed to the storage space is the same as an amount of the storage air portion.

14. The method of claim 12, wherein an amount of the ambient air portion is the same as an amount of the waste air portion.

15. The method of claim 12, wherein the first air portion is nitrogen.

16. The method of claim 12, wherein an amount of the first air portion directed to the storage space and an amount of the storage air portion are configured to maintain a desired pressure difference between a pressure in the storage space and an ambient pressure.

17. The atmosphere control system of claim 1, further comprising a CO₂ regulation device that scrubs CO₂ to regulate a CO₂ concentration within the storage space.

18. The method of claim 12, further comprising scrubbing CO₂ using a CO₂ regulation device to regulate a CO₂ concentration within the storage space.
